(19) United States
(12) Patent Application Publication
(10) Pub. No.: US 2017/0139808 A1
(43) Pub. Date: May 18, 2017

(54) METHOD AND DISPATCHER NODE FOR SERVER PROCESSING MANAGEMENT

(71) Applicants: LE HOLDINGS (BEIJING) CO., LTD., Beijing (CN); LECLOUD COMPUTING CO., LTD., Beijing (CN)

(72) Inventor: Hongfu Li, Beijing (CN)

(21) Appl. No.: 15/248,729

(22) Filed: Aug. 26, 2016

Related U.S. Application Data
(63) Continuation of application No. PCT/CN2016/083249, filed on May 25, 2016.

(30) Foreign Application Priority Data
Nov. 13, 2015 (CN) 201510781804.4

(51) Int. Cl. G06F 11/36

(52) U.S. Cl. CPC G06F 11/3632

(57) ABSTRACT

Techniques are disclosed for server process management, including sending by a dispatcher node a debugging access request received from a master node to a working process in a server to convert the working process into a debugging process; and during the debugging process, sending the working access request to the working process, except for the debugging process, in the server when the dispatcher node receives the working access request. Through the above method and the dispatcher node, server process management is realized while normal access to the server is not affected. Debugging steps of server processes are simplified. Operation and deployment of each process in the server during debugging of the server are realized.

### CROSS REFERENCE TO RELATED APPLICATIONS

This application is a continuation of International Application No. PCT/CN2016/083249, filed on May 25, 2016, which is based upon and claims priority to Chinese Patent Application No. 201510781804.4, filed on Nov. 13, 2015, the entire contents of each of which are incorporated herein by reference.

### TECHNICAL FIELD

The disclosure relates to the field of process management and, in particular, to a method and a dispatcher node for server processing management.

### BACKGROUND

With the development of electronic information technology, multiple processes are configured in a server to increase the processing speed of working access requests from users. However, during processing of the working access requests, the server randomly assigns a received working access request from the users to any one of the processes in the server.

When being debugged, one or more processes in a server may also receive and process users' working access requests, thus causing improper processing of the users' working access requests. As a result, user accesses are invalid, which seriously affects the user experience provided by the server.

A conventional solution to the above problems is to add a corresponding proxy process to each process in a server. The proxy processes distribute received working access requests to other processes when all processes in the server are debugged. However, in this way, destinations of forwarded working access requests cannot be determined as the proxy processes randomly forward the working access requests to other processes not in debugging during debugging of the server. Therefore, operation or deployment of the server processes during debugging of the server cannot be realized.

### SUMMARY

In view of the above, the application provides a method for server process management and an electronic device to solve problems regarding working access requests from users not being properly processed, and that the operation or deployment of server processes during debugging of a server cannot be realized.

To solve the above technical problems, an embodiment of the disclosure provides a method for server process management, which includes sending, by a dispatcher node, a debugging access request received from a master node to a working process in a server to convert the working process into a debugging process; and during the debugging proceeding of the debugging process, sending, by the dispatcher node, a working access request to the working process, except for the debugging process in the server, when the dispatcher node receives the working access request from the master node.

In another embodiment of the disclosure, a dispatcher node is provided. The dispatcher node may include, for example: at least one processor; and a memory communicably connected with the at least one processor configured to store instructions executable by the at least one processor, wherein execution of the instructions by the at least one processor causes the at least one processor to execute the method for server process management mentioned above.

In yet another embodiment of the disclosure, a non-transitory computer-readable storage medium is provided storing executable instructions that, when executed by a dispatcher node, cause the dispatcher node to execute the method for server process management mentioned above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart showing a method for server process management of the embodiments of the disclosure.

FIG. 2 shows a detailed execution chart of a specific implementation way of step S102 in the method as shown in FIG. 1.

FIG. 3 shows a detailed execution chart of a specific implementation way of step S103 in the method as shown in FIG. 1.

FIG. 4 shows a schematic drawing showing a system for server process management of the embodiments of the disclosure.

FIG. 5 is an architecture diagram of the method and system for server process management provided by the embodiments of the disclosure.

FIG. 6 is a structure diagram of an electronic device or a server capable of being applied to the embodiments of the disclosure.

### DETAILED DESCRIPTION

In order to make the purpose, technical solutions, and advantages of the embodiments of the invention more clearly, technical solutions of the embodiments of the disclosure will be described clearly and completely in conjunction with the figures. Obviously, the described embodiments are merely part of the embodiments of the disclosure, but do not include all possible embodiments. Based on the embodiments of the disclosure, other embodiments obtained by the ordinary skill in the art without undue experimentation are within the scope of the disclosure.

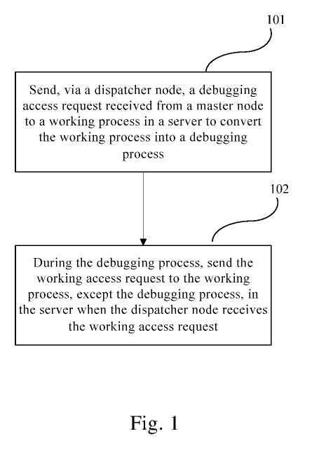

FIG. 1 is a flow chart showing a method for server process management of the embodiments of the disclosure. In an embodiment, the method may include, for example:

S101, sending a debugging access request received from a master node, by a dispatcher node, to a working process in a server to convert the working process into a debugging process, the master node classifying access requests into a debugging access request and a working access request, and sending the debugging access request and the working access request to the dispatcher node; and

S102, during debugging proceeding of the debugging process, sending, by the dispatcher node, the working access request to the working processes, except for the debugging process, in the server when the dispatcher node receives the working access request from the master node.

In an embodiment, after step S102, the method may further include restoring, by the dispatcher node, the debugging process to the working process after the debugging process is completed.

In various embodiments, the server described herein may be implemented as any suitable type of server configured to utilize any suitable type and/or number of communication protocols. For example, the server may be implemented as a Nginx server, which is a high-performance hypertext transfer protocol (HTTP) reverse proxy server, or may be any one of an Internet mail access protocol (IMAP) proxy server, a post office protocol 3 proxy server, and a simple mail transfer protocol (SMTP) proxy server. Nginx severs may be particularly useful, for example, when a high level of stability is desirable, as Nginx severs are known to have relatively higher stability, rich functional sets and example configuration files, and consume less system resources when compared to other types of servers.

In various embodiments of the disclosure, an Nginx server may be used as a debugging configuration server, and a to-be-debugged process corresponding to the debugging access request may be configured in the server and invoked to process the debugging access request. In this way, coordinated processing of the debugging access request and the working access request by each process in the server may be realized.

With respect to the specific execution, embodiments include step S101 including following sub-steps:

Determining, by the master node, whether the types of the access requests belong to the debugging access request or the working access request according to identification information in the access requests; and

sending the access requests with the determined types, by the master node, to the dispatcher node.

It should be understood that identification of the debugging access request may be stored in advance in the server. After the master node acquires access requests received by the server, identification of one access request is extracted, and the identification of the debugging access request stored in advance in the server is then inquired. When the identification of the access request is matched with that of the debugging access request, it is determined that the access request is the debugging access request. However, if the identification of the access request is unmatched with that of the debugging access request, it is determined that the access request is the working access request. In this way, whether the access requests received by the server belong to the debugging access request or the working access request can be determined.

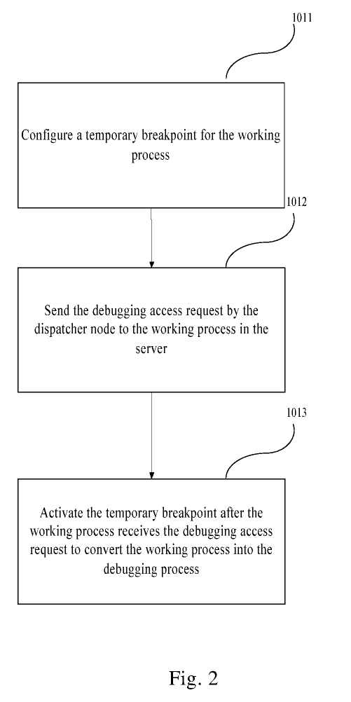

FIG. 2 shows a detailed execution chart of a specific implementation way of step S102 in the method as shown in FIG. 1. With respect to the specific execution, in an embodiment, step S101 may include the following sub-steps, as shown in FIG. 2:

S1011, configuring a temporary breakpoint, by the dispatcher node, for the working process;

S1012, sending the debugging access request, by the dispatcher node, to the working process in the server; and

S1013, activating the temporary breakpoint, by the dispatcher node, after the working process receives the debugging access request to convert the working process into the debugging process.

With respect to the specific execution, step S1011 may include the following steps.

Inquiring a debugging pairing ID of the debugging access request, by the dispatcher node, to acquire a process ID matched with the debugging pairing ID of the working process. One or more (or all) processes of the server may be configured with different respective process IDs. According to the process ID matched with the debugging pairing ID of the working process, the debugging access request by the dispatcher node may be assigned to a working process corresponding to the process ID. The process ID may then be matched with the debugging pairing ID, and the temporary breakpoint of the working process is activated to convert the working process into the debugging process.

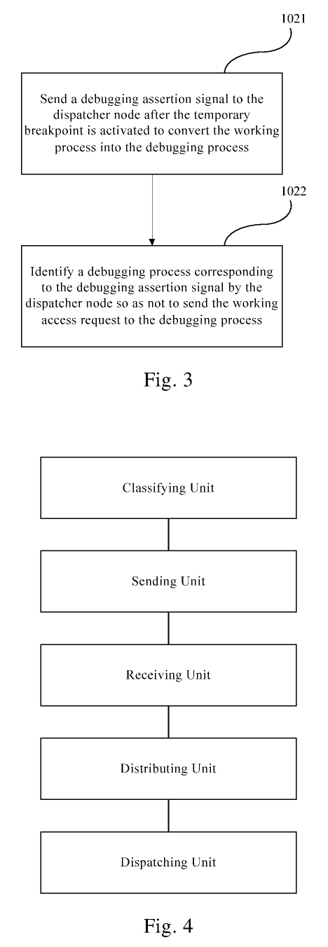

FIG. 3 shows a detailed execution chart of a specific implementation way of step S103 in the method as shown in FIG. 1. With respect to the specific execution, step S103 may include following sub-steps, as shown in FIG. 3:

S1021, sending a debugging assertion signal, by the debugging process, to the dispatcher node after the temporary breakpoint is activated to convert the working process into the debugging process; and

S1022, identifying a debugging process corresponding to the debugging assertion signal, by the dispatcher node, so as not to send the working access request to the debugging process.

With respect to the specific execution, embodiments include a further step such as revoking the temporary breakpoint by the debugging process and stopping sending the debugging assertion signal to the dispatcher node after the debugging process is completed to restore the debugging process to the working process. Thus, seamless switching between a process management state and a working state in the server can be realized, and the utilization ratio of the server processes can be increased.

The disclosure further provides a specific embodiment of a method for server process management, which may include, for example, the following steps.

The master node classifies access requests into a debugging access request and a working access request, and sends the debugging access request and the working access request to a dispatcher node. For example, an access request may include a data packet including a URL address, and identification may be a keyword of the URL address. Thus, it can be determined that the access request is the working access request for a server when the URL address of the access request includes a keyword such as “CCTV,” for example.

Identification of the debugging access request may be pre-stored in the server. For example, the identification of the debugging access request may be a keyword “DEBUG” contained in the debugging access request, and the keyword “DEBUG” may be a keyword added by a debugger to the debugging access request for identifying debugging.

The master node may acquire access requests received by the server. For example, identification of one access request is extracted, and then the identification of the debugging access request pre-stored in the server is inquired. When the identification of the access request is matched with that of the debugging access request, it is determined that the access request is the debugging access request. But, if the identification of the access request is unmatched with that of the debugging access request, it is determined that the access request is the working access request. For example, the master node may acquire one of the access requests in a preset period of time, and the server is inquired to determine whether the acquired access request contains “DEBUG,” which is a keyword for identifying debugging or not. If yes, the access request is determined as the debugging access request. Otherwise, the access request is determined as the working access request. In this way, whether the access requests received by the server belong to the debugging access request or the working access request can be determined, and the master node then sends the access requests whose type is determined to the dispatcher node.

In an embodiment, the dispatcher node may inquire a debugging pairing ID of the debugging access request to acquire a process ID, matched with the debugging pairing ID, of the working process. That is, one or more (or all) processes of the server are configured with different process IDs. According to the process ID (matched with the debugging pairing ID) of the working process, the dispatcher node assigns the debugging access request to the working process corresponding to the process ID. The process ID and the debugging pairing ID may be paired to activate the temporary breakpoint of the working process, so as to convert the working process into the debugging process. For example, each process in the server may be configured with a unique number as a process ID, the debugging access request is inquired to acquire a debugging pairing ID in the debugging access request, and a process matched with the debugging access request is determined. The debugging pairing ID may be, for example, a process that is added by a debugger to the debugging access request, and will be subject to debugging access by the debugging access request; and the debugging pairing ID and the process ID may be paired to activate the temporary breakpoint to group the processes in the server into a debugging process with an activated temporary breakpoint and a working process with an inactivated temporary breakpoint.

In an embodiment, the temporary breakpoint activating debugging process sends a debugging assertion signal to the dispatcher node, and the dispatcher node does not send a working access request to the debugging process sending the debugging assertion signal. For example, when a temporary breakpoint of one process in the server is activated, the process sends the debugging assertion signal to the dispatcher node, the dispatcher node receives and identifies the debugging assertion signal, the debugging process sending the debugging assertion signal is labeled as a debugging process by the dispatcher node, and the dispatcher node rejects sending a working access request to the debugging process.

In such a manner, all processes with activated temporary breakpoints in the server are labeled as debugging processes by the dispatcher node, and the dispatcher node rejects sending the working access request to all labeled debugging processes in the server. In an embodiment, all processes in the server may be in continuous communication with the dispatcher node. Moreover, the dispatcher node may be set to be in a state to receive a debugging assertion signal; one or more (or all) processes in the server may be set to be capable of sending the debugging assertion signal to the dispatcher node. The temporary breakpoint may be, for example, a trigger, and when the temporary breakpoint of one process in the server is triggered and activated, the debugging state of the process is activated such that the process in the server begins to send the debugging assertion signal to the dispatcher node. In a certain situation, the dispatcher node may position a process in the server according to a debugging process ID in the debugging assertion signal, and does not send the working access request to the debugging process.

Optionally, after the debugging process is completed, the debugging process revokes the temporary breakpoint and stops sending the debugging assertion signal to the dispatcher node, so as to enable the debugging process to be restored to the working process. For example, after the debugging process is completed, the debugging process may generate a debugging completion signal. After generation of the debugging completion signal is completed, the debugging process may then revoke the temporary breakpoint and stop sending the debugging assertion signal to the dispatcher node. After debugging of server processes is completed, they are switched from a debugging state to a working state. Thus, seamless switching between the debugging state and the working state of the server processes is realized, and the utilization ratio of the server processes is increased.

FIG. 4 shows a schematic drawing showing a system for server process management of the embodiments of the disclosure. In an embodiment, the method as shown in FIG. 1 may be realized by operating the following system described herein with reference to FIG. 4.

The system for server process management may include, for example, a master node and a dispatcher node, wherein the master node includes a classifying unit configured to classify access requests into a debugging access request and a working access request. The system may also include a sending unit configured to send the debugging access request and the working access request classified by the classifying unit to the dispatcher node. The dispatcher node may include a receiving unit configured to receive the debugging access request and the working access request sent by the sending unit of the master node. Furthermore, the system may include a distributing unit configured to distribute the debugging access request and working access request received by the receiving unit. Still further, the system may include a dispatching unit configured to control the distributing unit to send the debugging access request to a working process in a server to convert the working process into a debugging process, and control the distributing unit to send the working access request to the working process, except for the debugging process, in the server during the debugging process when the receiving unit receives the working access request.

In various embodiments, the system for server process management described herein may be implemented as any suitable number and/or type of computing device. For example, the system may be implemented as a server or a server cluster, wherein each unit may be a separate server or server cluster. In such a case, interaction among the above units is that among the servers or the server clusters corresponding to the units, and the plurality of servers or server clusters constitute the system for server process management provided by the disclosure.

In an alternate embodiment, several units in the above multiple units may together form a server or server cluster. For example, the classifying unit and the sending unit together may constitute a first server or a first server cluster, the receiving unit and the distributing unit may form a second server or a second server cluster, and the dispatching unit may constitute a third server or a third server cluster.

In such a case, the interaction among the above units is that among the first to third servers or the first to third server clusters, the first, second and third servers or the first, second and third server clusters constitute the system for server process management provided by the disclosure.

According to the system provided by the embodiments of the disclosure, the following purposes can be achieved:

1) The server can still work normally during debugging, and the working access requests received by the server can be properly processed, thus improving users' experience.

2) Compared with conventional techniques whereby each process in a server is added with a proxy process, only one dispatcher node is additionally arranged in the embodiments of the disclosure without adding the proxy processes to all processes in the server. Moreover, operation and deployment management of the server processes can be realized.

3) If the server is upgraded and a process is required to be added into the server, all that is needed in the embodiments of the disclosure is to perform corresponding configuration on the added dispatcher node, thus providing a convenient operation and on-line gray scale upgrading.

4) After debugging of processes that require debugging is completed, the debugged processes are put back into a working state again, so that seamless switching between the debugging state and the working state of the server processes is realized, and the utilization of the server processes is increased.

5) During debugging of the process in the server, if there are error codes in a debugging program, only a process debugged by the debugging program is affected, while other processes in the server are not affected. Moreover, isolation protection of the server processes can be realized when the debugging program contains error codes.

As a variation of the system provided by the embodiments of the disclosure, a process configuration unit may further be connected with the dispatching unit, and is configured to restore the debugging process to the working process after the debugging process is completed.

With respect to a specific working manner of the process configuration unit, the process configuration unit may include, for example:

a temporary breakpoint configuration module configured to set a temporary breakpoint for the working process; and

a process conversion module configured to activate the temporary breakpoint (which was configured by the temporary breakpoint configuration module) after the working process receives the debugging access request, to convert the working process into the debugging process, and to revoke the temporary breakpoint after the debugging process is completed to restore the debugging process to the working process.

The process configuration unit in the present embodiment may be implemented, for example, as a server or a server cluster, and each module may be a separate server or server cluster. Thus, in such a case, interaction among the above modules is that among the servers or the server clusters corresponding to respective units. The plurality of servers or server clusters may together form the process configuration unit to constitute the system for server process management provided by the disclosure.

In one alternative embodiment, several modules in the above multiple modules together may form a server or server cluster.

As a variation of the system provided by the embodiments of the disclosure, the process configuration unit further may include a debugging assertion module connected with the process conversion module and configured to send a debugging assertion signal to the debugging unit after a temporary breakpoint is activated to convert the working processing into the debugging process. The debugging unit is configured to identify a debugging process corresponding to the debugging assertion signal sent by the debugging assertion module, and to control the distributing unit not to send the working access request to the debugging process.

The specific working manner of the dispatching unit can be referred to the relevant descriptions in the above embodiments, and will not be repeated herein for purposes of brevity.

In various embodiments, the process configuration unit in the embodiments can described herein may be implemented as any suitable number and/or type of computing device. For example, the process configuration unit may be implemented as a server or a server cluster, wherein the debugging assertion module may be a separate server or server cluster. In such a case, the separate server or server cluster forms the debugging assertion module to constitute the process configuration unit so as to form the system for server process management provided by the disclosure.

In an embodiment, the classifying unit as shown in FIG. 4 may include, for example:

an identifying module configured to recognize identification information in the access requests; and

a determining module configured to determine whether the types of the access requests belong to the debugging access request or the working access request according to the identification information identified by the identifying module.

The classifying unit in the embodiments described herein may be, for example, a server or a server cluster, wherein each module may be a separate server or server cluster. In such a case, interaction among the above modules is that among the servers or the server clusters corresponding to respective units, and the plurality of servers or server clusters together may form the classifying unit to constitute the system for server process management provided by the disclosure.

In an alternate embodiment, several modules in the above multiple modules together may form a server or server cluster.

The specific working manner of the classifying unit can be referred to the relevant descriptions in the above embodiments, and will not be repeated herein for purposes of brevity.

It should be explained that each process in the server may be in continuous communication with the dispatcher node. Moreover, the dispatcher node may be set to be in a state to receive a debugging assertion signal. One or more (or all) of the processes in the server may be set to be capable of sending the debugging assertion signal to the dispatcher node. The temporary breakpoint may be, for example, a trigger. Thus, when the temporary breakpoint of one process in the server is triggered and activated, the debugging state of the process is activated, and the process in the server begins to send the debugging assertion signal to the dispatcher node.

The above functional modules and units discussed in the embodiments of the disclosure can be implemented, for example, through software in conjunction with general-purpose hardware, or directly via hardware implementations (e.g., via a hardware processor).

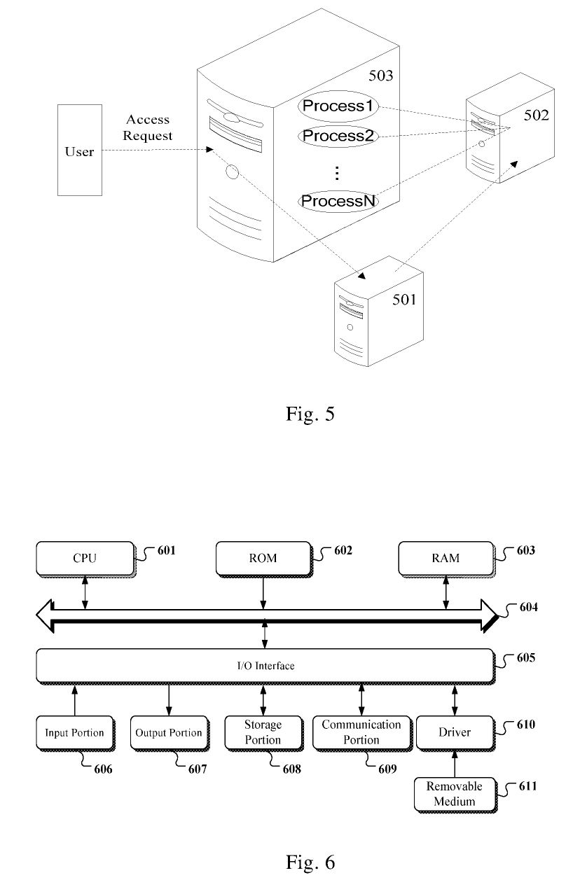

FIG. 5 is an architecture diagram of the method and system for server process management provided by the embodiments of the disclosure. The architecture diagram as shown in FIG. 5 includes a master node 501, a dispatcher node 502, a server 503, and any suitable number N of server processes such as a server process 1, a server process 2, . . . , and a server process N. After server 503, as shown in the architecture diagram, receives a plurality of access requests sent by a user via a client (e.g., via an intelligent terminal), the master node 501 classifies the access requests into a debugging access request and a working access request, and sends the debugging access request and the working access request to the dispatcher node 502. Dispatcher node 502 sends the debugging access request to a working process in server 503 to convert a working process to a debugging process. During the debugging process, when receiving the working access request, dispatcher node 502 sends the working access request to the working process, except for the debugging process, in the server, so that normal operation of the server processes in a debugging stage is ensured, and improved user access experience of the server is realized.

An embodiment of the present application provides a non-transitory computer-readable storage medium storing executable instructions thereon that, when executed by an electronic device, cause one or more processors associated with the electronic device to execute the method for server process management mentioned above.

FIG. 6 is a structure diagram of an electronic device or a server capable of being applied to the embodiments of the disclosure. In the example shown in FIG. 6, the server constitutes a dispatch node, which can be implemented by an electronic device or a server computer system applied to the embodiments of the disclosure. The dispatch node as shown in FIG. 6 includes a processor such as a central processing unit (CPU) 601, which can perform various appropriate actions and processing functions according to a program stored in a read-only memory (ROM) 602 or a program loaded to a random access memory (RAM) 603 from a storage portion 608. Various programs and/or data required during operation of the system may also be stored in RAM 603. CPU 601, ROM 602, and the RAM 603 may be connected with one another via a bus 604. An Input/output (I/O) interface 605 may also be connected to bus 604.

Components connected to Input/output (I/O) interface 605 may include, for example, an input portion 606 that includes, for example, a keyboard, a mouse, and the like, an output portion 607 that includes, for example a cathode ray tube (CRT), a liquid crystal display (LCD), and the like, a storage portion 608 that includes, for example, a hard disk, and the like, and a communication portion 609 of network interface cards that includes, for example an LAN card, a modem, etc. Communication portion 609 may perform communication processing via a network such as the Internet. A driver 610 may be connected to the Input/output (I/O) interface 605 as needed to ensure proper operation. A removable medium 611 such as a magnetic disk, an optical disk, a magneto-optical disk, a semiconductor memory, etc., may be installed on the driver 610 as required so as to enable a computer program to read out from the removable medium to be installed into the storage portion 608 according to the needs.

In the dispatcher node shown in FIG. 6, execution of the instructions by the processor (CPU 601) causes the processor to: send a debugging access request received from a master node to a working process in a server to convert the working process into a debugging process; and during the debugging proceeding of the debugging process, send a working access request to working processes, except for the debugging process, in the server when the dispatcher node receives the working access request from the master node.

Particularly, according to the embodiments of the disclosure, the steps described in the above reference flow chart can be implemented as a computer program. For example, the embodiments of the disclosure may include a computer program product including a computer program which is tangibly contained in a machine-readable medium, and the computer program may include a program code for performing the method as shown in the flow chart. In accordance with such embodiments, the computer program can be downloaded and installed from the network via the communication portion 609, and/or can be installed from the removable medium 611.

In one aspect of application of the disclosure, the system for server process management provided by the embodiments of the disclosure can be embedded in a website server as a functional element. In another aspect of application of the disclosure, the system for server process management provided by the embodiments of the disclosure can also be embedded in a cloud server connected between the website server and a user terminal.

It should be noted that, embodiments of the present application and the technical features involved therein may be combined with each other in case they are not conflict with each other. Terms like “comprise”, “include”, and the like are to be construed as including not only the elements described, but also those elements not specifically described, or further including elements which are essential to such process, method, article or device. Unless the context clearly requires, throughout the description and the claims, elements defined by recitation with “including . . . ” should not be construed as exclusive from the process, method, article or device including said elements of other equivalent elements.

The foregoing embodiments are illustrative, in which those units described as separate parts may or may not be separated physically. Illustrated components may or may not be physical units, i.e., may be located in one place or distributed in several locations among a network. Some or all modules may be selected according to practical requirement to realize the purpose of the embodiments, and such embodiments can be understood and implemented by the skilled person in the art without undue experimentation.

A person skilled in the art can clearly understand from the above description of embodiments that these embodiments can be implemented through software in conjunction with general-purpose hardware, or directly via hardware implementations. Based on such understanding, the essence of foregoing technical solutions, or those features making contribution to the prior art may be embodied as software product stored in computer-readable medium such as ROM/RAM, diskette, optical disc, etc., and including instructions for execution by a computer device (such as a personal computer, a server, or a network device) to implement methods described by foregoing embodiments or a part thereof.

Finally, it should be noted that, the above embodiments are provided to describe the technical solutions of the disclosure, but are not intended as a limitation. Although the disclosure has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the disclosure.

What is claimed is:

1. A method for server process management, comprising:
sending, by a dispatcher node, a debugging access request received from a master node to a working process in a server to convert the working process into a debugging process; and
during execution of the debugging process, sending, by the dispatcher node, a working access request to a working process, except for the debugging process, in the server when the dispatcher node receives the working access request from the master node.

2. The method of claim 1, wherein the method further comprises:
restoring, by the dispatcher node, the debugging process to the working process after the debugging process is completed.

3. The method of claim 1, wherein the act of sending the debugging access request by the dispatcher node to the working process in the server to convert the working process into the debugging process comprises:
sending the debugging access request by the dispatcher node to the working process in the server to activate a temporary breakpoint configured in the working process after the working process receives the debugging access request to convert the working process into the debugging process.

4. The method of claim 3, wherein the act of sending the working access request received from the master node to the working process comprises:
identifying a debugging process corresponding to a debugging assertion signal received from the debugging process by the dispatcher node so as not to send the working access request to the debugging process.

5. The method of claim 1, wherein the debugging access request and the working access request are identified according to identification information in access requests.

6. A dispatcher node, comprising:
at least one processor; and
a memory communicably connected with the at least one processor configured to store instructions executable by the at least one processor, wherein execution of the instructions by the at least one processor causes the at least one processor to:
send a debugging access request received from a master node to a working process in a server to convert the working process into a debugging process; and
during execution of the debugging process, send a working access request to working processes, except for the debugging process, in the server when the dispatcher node receives the working access request from the master node.

7. The dispatcher node of claim 6, wherein execution of the instructions by the at least one processor further causes the at least one processor to restore the debugging process to the working process after the debugging process is completed.

8. The dispatcher node of claim 6, wherein execution of the instructions by the at least one processor further causes the at least one processor to:
activate a temporary breakpoint configured in the working process after the working process receives the debugging access request to convert the working process into the debugging process, and to revoke the temporary breakpoint after the debugging process is completed to restore the debugging process to the working process.

9. The dispatcher node of claim 6, wherein execution of the instructions by the at least one processor further causes the at least one processor to identify a debugging process corresponding to the debugging assertion signal received from the debugging process so as not to send the working access request to the debugging process.

10. The dispatcher node of claim 6, wherein the debugging access request and the working access request are identified according to identification information of access requests.

11. A non-transitory computer-readable storage medium storing executable instructions that, when executed by a dispatcher node, cause a dispatcher node to:
send a debugging access request received from a master node to a working process in a server to convert the working process into a debugging process; and
during execution of the debugging process, send a working access request to working processes, except for the debugging process, in the server when the dispatcher node receives the working access request from the master node.

12. The non-transitory computer-readable storage medium of claim 11, wherein execution of the instructions by the dispatcher node further causes the dispatcher node to restore the debugging process to the working process after the debugging process is completed.

13. The non-transitory computer-readable storage medium of claim 11, wherein execution of the instructions by the dispatcher node further causes the dispatcher node to:
activate a temporary breakpoint configured in a working process after the working process receives the debugging access request to convert the working process into the debugging process, and to revoke the temporary breakpoint after the debugging process is completed to restore the debugging process to the working process.

14. The non-transitory computer-readable storage medium of claim 11, wherein execution of the instructions by the dispatcher node further causes the dispatcher node to identify a debugging process corresponding to a debugging assertion signal received from a debugging process by the dispatcher node so as not to send the working access request to the debugging process.

15. The non-transitory computer-readable storage medium of claim 11, wherein execution of the instructions by the dispatcher node further causes the dispatcher node to:
identify identification information in the access requests; and
determine whether the type of the access request belongs to the debugging access request or the working access request according to the identification information.
